(19) United States
(12) Patent Application Publication
(10) Pub. No.: US 2015/0357891 A1
(43) Pub. Date: Dec. 10, 2015

(54) ROTATING ELECTRIC MACHINE SYSTEM AND METHOD FOR CONTROLLING INDUCED VOLTAGE FOR THE SAME

(71) Applicant: Yoshikazu ICHIYAMA, Fuchu-shi (JP)

(72) Inventor: Yoshikazu ICHIYAMA, Fuchu-shi (JP)

(21) Appl. No.: 14/726,612

(22) Filed: Jun. 1, 2015

Related U.S. Application Data
(63) Continuation of application No. PCT/JP2015/061931, filed on Apr. 20, 2015.

(30) Foreign Application Priority Data
Jun. 6, 2014 (JP) 2014-117294
Jul. 4, 2014 (JP) 2014-138276
Aug. 18, 2014 (JP) 2014-165617
Dec. 9, 2014 (JP) 2014-248975
Jan. 21, 2015 (JP) 2015-009027

(51) Int. Cl. H02K 16/02; H02K 1/28; H02K 1/27

(52) U.S. Cl. CPC H02K 16/02; H02K 1/276; H02K 1/28

(57) ABSTRACT

In the rotating electric machine system, a rotor facing an armature is composed of three rotors having magnetic salient poles of the same number, rotors at both ends are magnet excited configuration, rotors at both ends are displaced relatively in mutually opposite circumferential direction to a middle rotor, and rotational force is optimally controlled. The middle rotor can adopt the rotor structure to have a reluctance torque, a magnet torque, and both. The rotating electric machine system that can adopt an optimum magnetic pole structure by a rotor unit, and has a wide range of the rotational speed is provided.

### CROSS-REFERENCE TO RELATED APPLICATIONS

The present application is a continuation application of International Application No. PCT/JP2015/61931, filed Apr. 20, 2015, which claims priority to Japanese Patent Application No. 2014-117294, filed Jun. 6, 2014, Japanese Patent Application No. 2014-138276, filed Jul. 4, 2014, Japanese Patent Application No. 2014-165617, filed Aug. 18, 2014, Japanese Patent Application No. 2014-248975, filed Dec. 9, 2014, and Japanese Patent Application No. 2015-009027, filed Jan. 21, 2015. The contents of these applications are incorporated herein by reference in their entirety.

### BACKGROUND OF THE INVENTION

1. Field of the Invention

This invention relates to a rotating electric machine system and a method for controlling an induced voltage for the rotating electric machine system.

2. Discussion of the Background

The rotating electric machine with embedded permanent magnets in the magnetic material in the vicinity of the rotor surface (IPM) is widely used by the reason that field-weakening by phase control of the drive current is possible. However, further rotational speed range expansion of the IPM can not be expected because of the incomplete field weakening. As other methods of the field weakening, there is a proposal to displace one of two divided magnet excitation rotors with respect to the other, and to control magnetic flux phase interlinking with the armature coil (U.S. Pat. No. 3,713,015, Japanese Patent Laid-Open No. Hei10-155262, Japanese Patent Laid-Open No. 2002-165426, Japanese Patent Laid-Open No. 2010-154699). This method can achieve a motor having wide rotating speed range without sacrificing high energy efficiency of magnet excitation.

### SUMMARY OF THE INVENTION

The rotating electric machine system by this invention is configured as three rotors having magnetic salient poles of the same number are queued up axially, the rotors at axial both ends are excited by permanent magnets at least, one of the rotors is fixed to a rotating shaft as a fixed rotor, and the other two rotors are configured to be displaceable in the circumferential direction relative to the fixed rotor as displacement rotors. In addition, a rotor position control device is arranged, when induced voltage is bigger than predetermined value, the rotor position control device makes the rotors in both ends displace relatively in reverse circumferential direction each other to a middle rotor, makes each of the displacement amount large, and makes the induced voltage smaller. When induced voltage is smaller than predetermined value, the rotor position control device makes each of the displacement amount smaller, and makes the induced voltage bigger. And the rotating force is optimally controlled.

The magnetic salient pole indicates segment magnetized by permanent magnet or magnetic segment to be convex shape by non-magnetic material including air gap in the rotor periphery facing the armature. In case of magnet excitation structure, number of the magnetic salient pole is assumed to be number of segments of which adjacent segments are magnetized each other in opposite polarities.

Furthermore, various magnetic pole compositions can be adopted for the middle rotor of this invention. That is, the polarity of the driving current is switched based on a relative position between the armature coil and the middle rotor, and the rotor is driven to rotate. Therefore, the middle rotor has small constraints on, and can adopt the rotor structure to have a reluctance torque, a magnet torque, and both. Especially, the middle rotor is assumed to be a magnetic pole structure that the rotational force is obtained by the reluctance torque, and the both ends rotors can be assumed to be a magnetic pole structure that the rotational force is obtained by the magnet torque.

The rotors at both ends are displaced relatively to the middle rotor. In realized constitution, a rotor in axial one end is fixed to the rotating shaft, and other two rotors are made to be displaced. Or the middle rotor is fixed to the rotating shaft, and the rotors at both ends are made to be displaced. Output that is object of optimization is output torque, braking force in the regenerative braking, and generation voltage.

This invention provides rotor coupling mechanism that mechanically unites the three rotors in order to simplify the displacement control. That is, the three rotors are combined mechanically so that when either of two displacement rotors is displaced in the circumferential direction, the rotors at both ends may be displaced relatively in reverse circumferential direction each other to the middle rotor.

Moreover, following composition is also possible. That is, three rotors having magnetic salient poles of the same number are arranged in the axial direction, one of the rotors is fixed to a rotating shaft as a fixed rotor, the other two rotors are configured to be displaceable in the circumferential direction relative to the rotating shaft as displacement rotors, and the displacement rotors are displaced in the opposite circumferential direction to each other with respect to the rotating shaft and the fixed rotor. The displacement rotors are excited by permanent magnets, when induced voltage is bigger than predetermined value, they are displaced larger relatively in reverse circumferential direction each other, and the induced voltage is made smaller, when the induced voltage is smaller than predetermined value, each of the displacement amount is made smaller, and the induced voltage is made bigger, and rotational force is optimally controlled.

The rotor position control device has a structure to bind the displacement rotor to the rotating shaft at least, and to control displacement. There are various devices. For example, a planetary gear mechanism, a clutch mechanism, a mechanism using a groove interlinked oblique to the rotating shaft, a hydraulic control mechanism, and the like. It is possible to execute the displacement control of the two rotors each independently, or at the same time by using the rotor coupling mechanism between rotors. Moreover, the composition by the actuator output exclusively and the composition by exploiting rotational drive force are possible as the composition for the rotor displacement.

The three rotors having magnetic salient poles of the same number are arranged in the axial direction, two of the rotors are displaced relatively in mutually opposite circumferential direction to a remaining rotor, and rotational force is optimally controlled. The rotating electric machine system that can adopt an optimum magnetic pole by a rotor unit, and has a wide range of the rotational speed is provided.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a longitudinal sectional view of a rotating electric machine apparatus according to a first embodiment of the present invention;

FIG. 2 is a sectional view along A-A′ of the rotating electric machine apparatus shown in FIG. 1;

FIG. 3 is a plan view of a first rotor of the rotating electric machine apparatus shown in FIG. 1 seen from a second rotor side;

FIG. 4 is a perspective view in model manner showing relative displacement direction of the first rotor and a third rotor to the second rotor in the rotating electric machine apparatus shown in FIG. 1;

FIG. 5 is a plan view seen from a rotating shaft in model manner showing relative displacement direction of the first rotor and a third rotor to the second rotor in the rotating electric machine apparatus shown in FIG. 1;

FIG. 6 is a perspective view for explaining a rotor coupling mechanism;

FIG. 7 is a sectional view along B-By of the rotating electric machine apparatus shown in FIG. 1;

FIGS. BA and 8B are figures showing a stopper that restricts the displacement amount of the first rotor in the rotating electric machines shown in FIG. 1. FIG. 8A is a plan view showing a first sun gear 1f seen from a second sun gear 1g side, and FIG. 8B is a plan view showing the second sun gear 1g seen from the first sun gear 1f side;

FIG. 9 shows the relationship between rotational torque, drive current and rotational speed of the rotating electric machine apparatus shown in FIG. 1;

FIG. 10 is a block diagram of a rotating electric machine system that controls the induced voltage;

FIG. 11 is a perspective view in model manner showing example of changing the arrangement of rotors in the rotating electric machine apparatus shown in FIG. 1;

FIG. 12 is a longitudinal sectional view of a rotating electric machine apparatus according to a second embodiment of the present invention;

FIG. 13 is a sectional view along C-C′ of the rotating electric machine apparatus shown in FIG. 12;

FIG. 14 is a plan view of a first rotor of the rotating electric machine apparatus shown in FIG. 12 seen from the second rotor side;

FIG. 15 is a perspective view in model manner showing relative displacement direction of the first rotor and a third rotor to the second rotor in the rotating electric machine apparatus shown in FIG. 12;

FIG. 16 indicates a rotor position control device in the rotating electric machine apparatus shown in FIG. 12 seen from the first rotor side;

FIG. 17 indicates magnified view of the rotor position control device in the rotating electric machine apparatus shown in FIG. 12, and indicates a state where rotational force is transmitted via a clutch plate;

FIG. 18 indicates magnified view of the rotor position control device in the rotating electric machine apparatus shown in FIG. 12, and indicates a state where rotational force is not transmitted via the clutch plate; and

FIG. 19 is a perspective view in model manner showing example of changing the magnetic pole part configuration of rotors in the rotating electric machine apparatus shown in FIG. 12.

### DESCRIPTION OF THE EMBODIMENTS

The embodiments will now be described with reference to the accompanying drawings, wherein like reference numerals designate corresponding or identical elements throughout the various drawings.

### First Embodiment

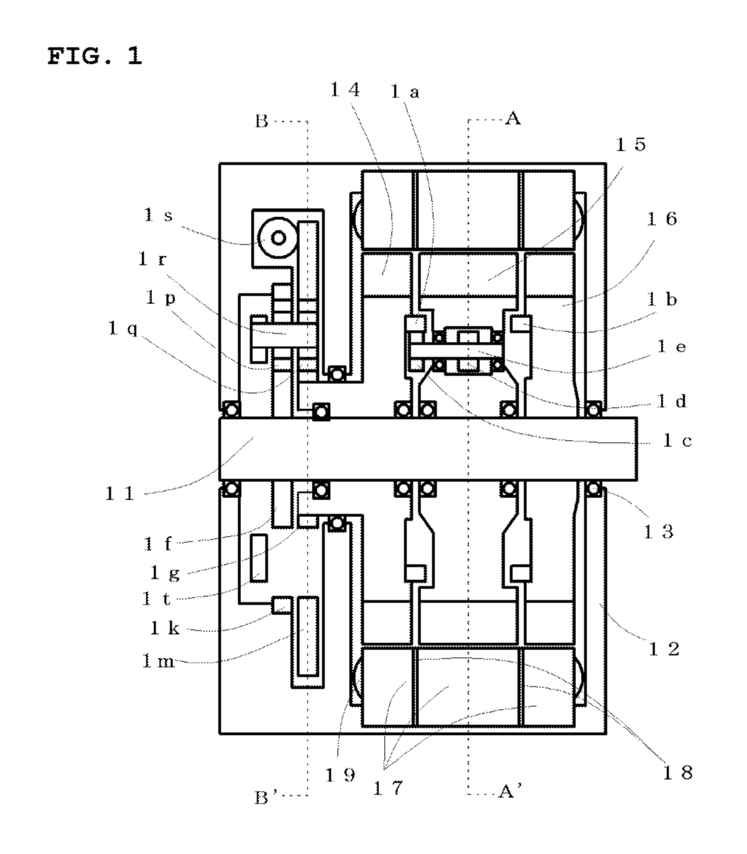

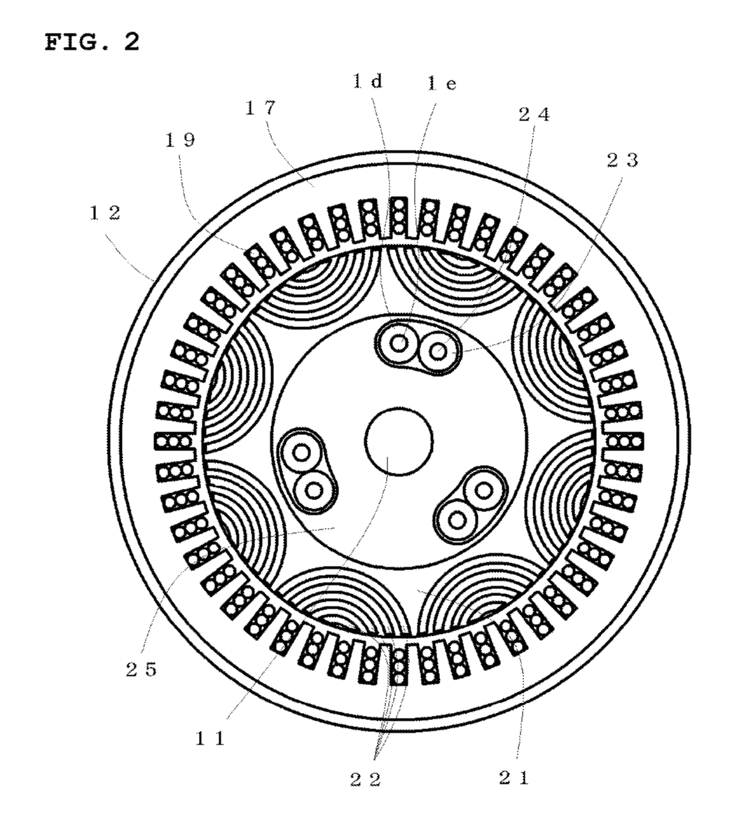

The rotating electric machine system according to a first embodiment of the present invention will be explained by using FIGS. 1 to 10. Three rotors are opposite to an armature as a first rotor, a second rotor and a third rotor. The first rotor and the second rotor are displaced to the third rotor in the circumferential direction using a planetary gear mechanism. The first rotor and the third rotor are magnet excited, and the second rotor is configured so as to obtain the rotational force by the reluctance torque.

FIG. 1 shows a longitudinal sectional view of the embodiment in which the present disclosure is applied to the rotating electric machine apparatus of an inner rotor structure, a rotating shaft 11 is supported rotatably by a housing 12 through bearings 13. The first rotor 14 and the second rotor 15 are displaceably held on the rotating shaft 11 through bearings, the third rotor 16 is fixed to the rotating shaft 11. Region where the first rotor 14 and the second rotor 15 are displaced is forward of rotational direction in common use against the third rotor 16. The ratio of axial length of the first rotor 14, the second rotor 15 and the third rotor 16 is set at 1:2:1. Numbers 19, 17, and 18 indicate an armature coil, an armature core, and a spacer made from non-magnetic insulating material, respectively. The thickness of the spacer 18 is smaller than interval between adjacent rotors.

Numbers 1a, 1b, 1c, 1e, and 1d indicate a side gear fixed on side surface of the first rotor 14, a side gear fixed on side surface of the third rotor 16, a coupling gear that meshes with the side gear 1a, a coupling gear support shaft, and a coupling gear fixed to the coupling gear support shaft 1e, respectively. The coupling gear support shaft 1e is rotatably supported on the second rotor 14. A coupling gear which meshes with the side gear 1b, a coupling gear which meshes with the coupling gear 1d, and a support shaft thereof are not shown in FIG. 1, but a rotor coupling mechanism includes side gears, coupling gears mentioned above, and will be described later.

Numbers 1f, 1k, and 1p indicate a first sun gear fixed to the rotating shaft 11, a first ring gear fixed to the housing 12, and a first planetary gear which meshes with the first sun gear 1f and the first ring gear 1k, respectively. And the first planetary gear 1p is rotatably supported on a planetary gear shaft 1r, a first planetary gear mechanism is constituted by these gears. Numbers 1g, 1m, and 1q indicate a second sun gear fixed to the first rotor 14, a second ring gear supported rotatably by the housing 12, and a second planetary gear which meshes with the second sun gear 1g and the second ring gear 1m, respectively. And the second planetary gear 1q is rotatably supported on the planetary gear shaft 1r, a. second planetary gear mechanism is constituted by these gears.

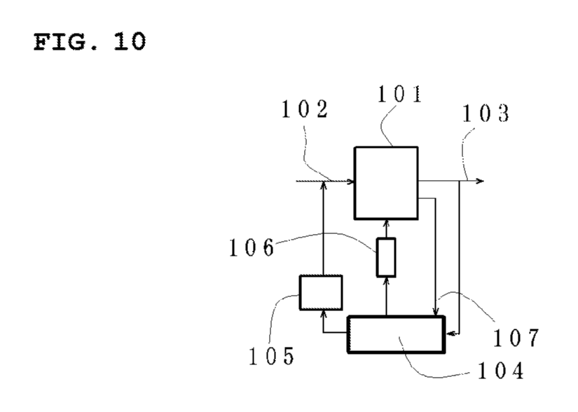

Three sets of the first planetary gear 1p, the second planetary gear 1q, and the planetary gear shaft 1r are arranged in the circumferential direction, and the planetary gear shafts 1r are supported on a planetary gear carrier 1t. A number is indicates a worm gear and is configured to mesh with a gear carved with the second ring gear 1m side. In addition, the worm gear 1s is connected with an actuator not shown in the figure so as to be driven to rotate. The first sun gear 1f and the second sun gear 1g, the first ring gear 1k and the second ring gear 1m, the first planetary gear 1p and the second planetary gear 1g are gears of each same specifications. A rotor position control device includes two sets of planetary gear mechanism mentioned above, the actuator 106 (see FIG. 10), a rotor coupling mechanism (see FIG. 6) and the worm gear 1s.

FIG. 2 illustrates a sectional view of the armature and the second rotor 15 along A-A′ of FIG. 1. The armature core 17 is formed by laminating silicon steel plates, 48 of armature coils 19 are arranged. U-phase, V-phase, W-phase coils are arranged repeatedly in order of U+, U+, V−, V−, W+, W+, U−, U−, V+, V+, W− and W−. + and − following U, V, and W show the polarity of the current.

The second rotor 15 is composed of a second rotor support 25, and magnetic pole part arranged on outer periphery thereof. The magnetic pole part is formed by laminating silicon steel sheets 21 with arc slits of the convex inward, non-magnetic substance 22 is inserted in the arc slits, and the flux barrier is composed. The magnetic resistance along outer periphery of the second rotor 15 is periodically assumed to be large and small, and eight magnetic salient poles (8 poles) are arranged.

The second rotor support 25 consists of non-magnetic stainless steel, and is displaceably held on the rotating shaft 11. Three sets of mutually intermeshing coupling gear 1d, the coupling gear 23 are located on the second rotor support 25. The coupling gear support shaft 24 that rotates together with the coupling gear 23 is rotatably supported on the second rotor support 25 as well as the coupling gear support shaft 1e.

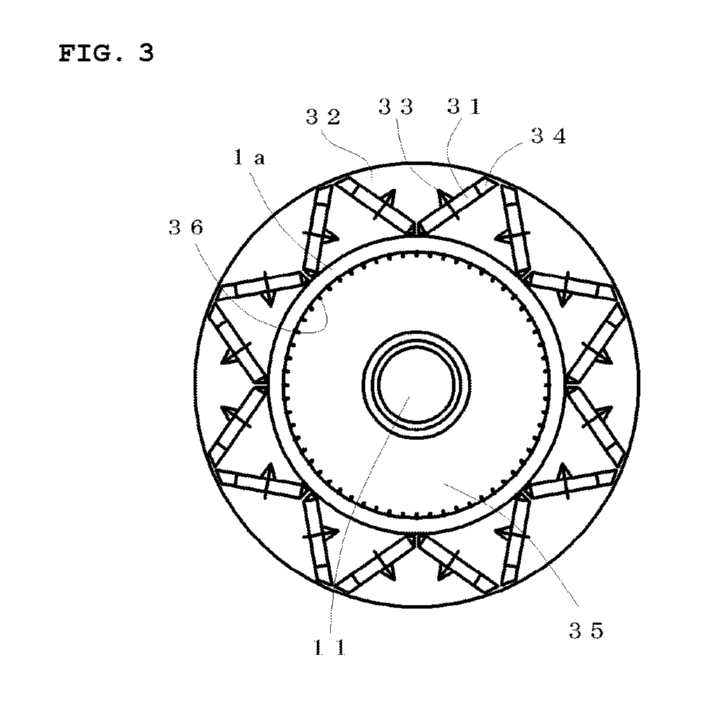

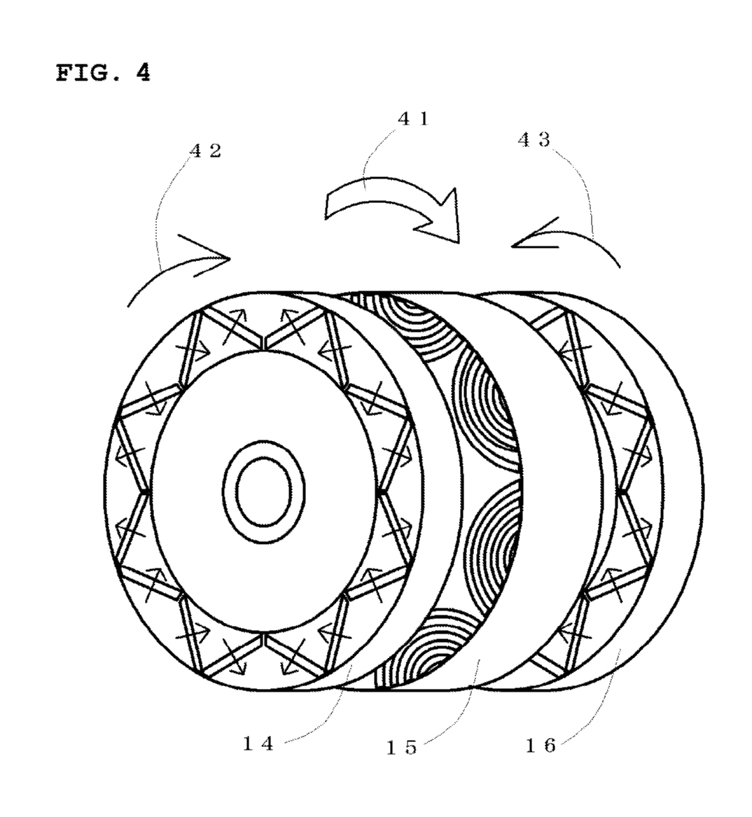

FIG. 3 is a plan view of the first rotor 14 seen from the second rotor 15 side. The magnetic pole part consists of a rotor core 32 that silicon steel plates are laminated, a permanent magnet 31, a non-magnetic material 34. Polarities of 8 magnetic salient poles are turned over alternately in circumferential direction. An arrow 33 indicates magnetization direction of the permanent magnet 31. The side gear 1a is placed for the first rotor support 35, and a gear 36 meshing with the coupling gear 1c is engraved on internal perimeter surface of the side gear 1a. The side gear 1b disposed on the third rotor 16 side shown in FIG. 1 is same shape as the side gear 1a. Magnetic pole constitution of the third rotor 16 is the same as the first rotor 14.

In this embodiment, the third rotor 16 is fixed to the rotating shaft 11, the first rotor 14 and the second rotor 15 are displaced to the third rotor 16 in the rotating direction. However, based on the second rotor 15 in the middle, the first rotor 14 and the third rotor 16 are displaced relatively in the circumferential. direction opposite to each other with respect to the second rotor 15, and induced voltage of the armature coil 19 is controlled. FIG. 4 is a perspective view in model manner showing relative displacement direction of the first rotor 14 and the third rotor 16 to the second rotor 15. Arrows 42, 43 indicate the direction in which the first rotor 14, the third rotor 16 is displaced relative to the second rotor 15, respectively. Arrow 41 indicates the direction of rotation of the entire rotor. The second rotor 15 is composed so that the inductance of the armature coil 19 may change periodically with the rotation by the arc slit arranged in the magnetic substance, and obtains the rotational force by the reluctance torque.

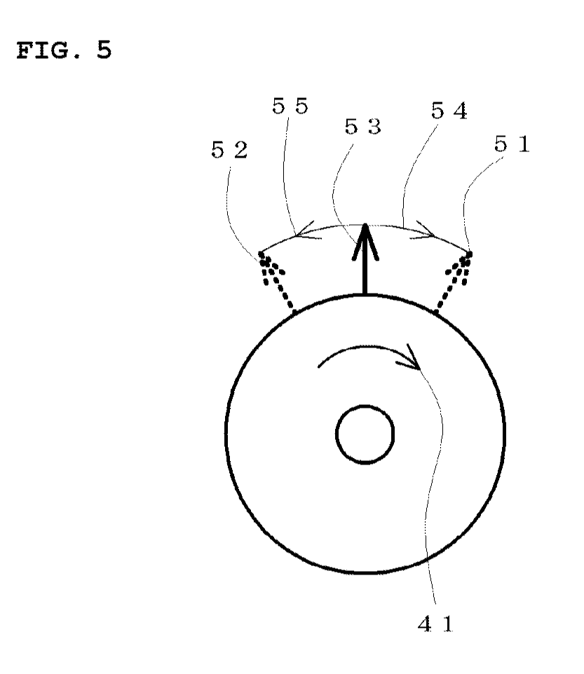

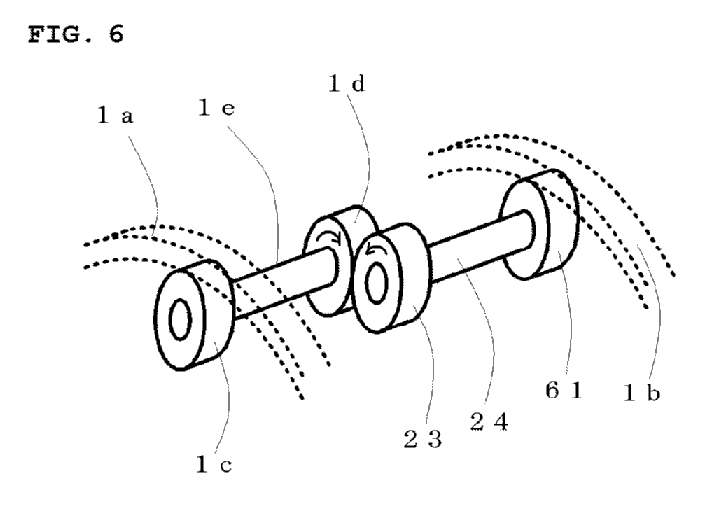

FIG. 5 shows a plan view of the rotor shown in FIG. 4 from the rotating shaft 11 side. Numbers 51 and 52 show displaced positions of the first rotor 14 and the third rotor 16 respectively having been at a reference position 53, numbers 54 and 55 show the displacement magnitude of the first rotor 14 and the third rotor 16 to the second rotor 15 respectively. Since amounts of displacement 54 and 55 are equal, synthetic position of 51 and 52 is the same as the reference position 53, and exist at the same circumferential position on the second rotor 15. Therefore, the polarity of the driving current is switched based on the relative position between the armature coil 19 and the second rotor 15.

The driving current polarity is assumed to be switched according to the timing that armature coil 19 opposes to the reference position 53 (synthetic position of the 51, 52), the first rotor 14, the second rotor 15, the third rotor 16 are arranged so that each torque may become the maximum. So when displacement amounts 54 and 55 become larger than zero, the first rotor 14 and the third rotor 16 are equivalent to be rotated by driving current of the phase advance or delay phase, respectively with respect to the second rotor 15. Therefore, there is a possibility of the appearance of the reluctance torque of a reverse-polarity in the rotors at both ends mutually and causing the torque fluctuation of the rotor.

Since the rotors at both ends have the magnetic pole structures that the magnet torque and the reluctance torque are obtained in this embodiment, the above-mentioned position 51 and 52 are in a position advanced approximately 20 electrical degrees from the magnetic pole center of the first rotor 14 and the third rotor 16, respectively. When displacement amounts 54 and 55 are greater than zero, synthetic position of magnetic pole center of the first rotor 14 and magnetic pole center of the third rotor 16 is assumed as a second reference position, the driving current polarity is changed to be switched according to the timing that armature coil 19 opposes to the second reference position, the above-mentioned reluctance torque of the opposite polarity are canceled out, torque fluctuation is suppressed. The second reference position corresponds to position that is delayed about 20 electric degrees from the reference position 53.

FIG. 6 is a perspective view in a model manner for the rotor coupling mechanism of which some members are shown in FIGS. 1, 2 and 3. The coupling gear support shafts 1e and 24 are rotatably supported by the second rotor 15, the coupling gears 1c and 1d are fixed to the coupling gear support shaft 1e, and the coupling gears 23 and 61 are fixed to the coupling gear support shaft 24. The coupling gear 1d and the coupling gear 23 are arranged to mesh with each other. The coupling gear 1c meshes with the gear 36 engraved on internal perimeter surface of the side gear 1a, the coupling gear 61 meshes with a gear engraved on internal perimeter surface of the side gear 1b.

The rotor coupling mechanism includes the coupling gears 1c, 1d, 23, 61, the coupling gear support shafts 1e, 24. And three sets of the coupling gears arranged in the circumferential direction are coupled with the side gears 1a and 1b. The coupling gears 1d and 23 rotate in an opposite direction each other, so when either of the first rotor 14 and the third rotor 16 is displaced in circumferential direction to the second rotor 15, the other is displaced in reverse circumferential direction. The third rotor 16 is fixed to the rotating shaft 11 in the present embodiment, the first rotor 14 and the second rotor 15 are configured so as to be displaceable in the same circumferential direction with respect to the third rotor 16. Therefore the ratio of the circumferential direction interval between the third rotor 16 and the second rotor 15 and the circumferential direction interval between the third rotor 16 and the first rotor 14 is always kept by 1:2.

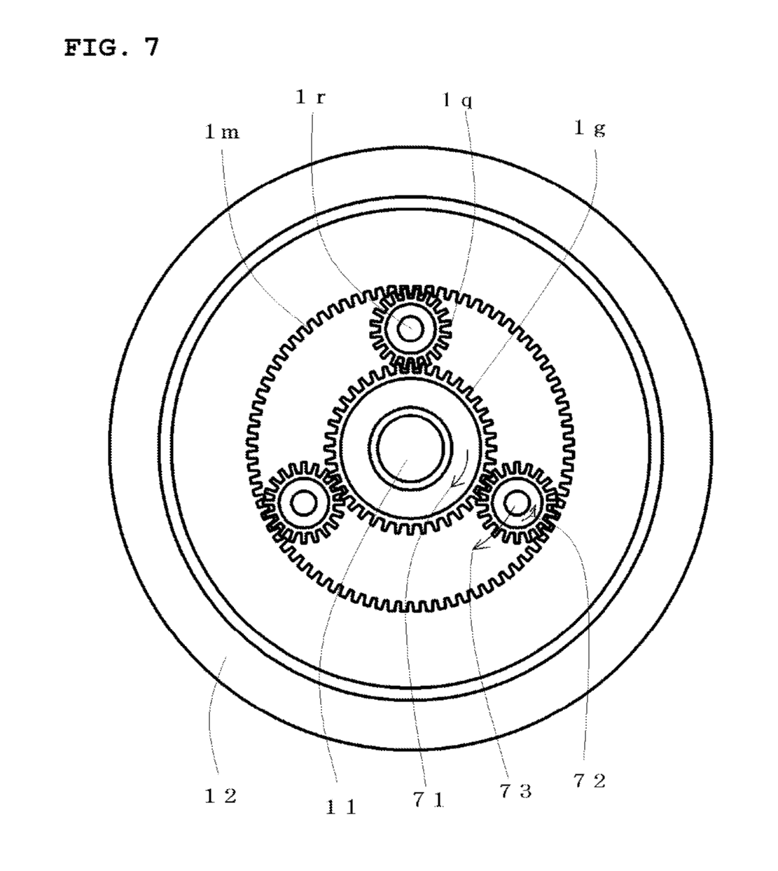

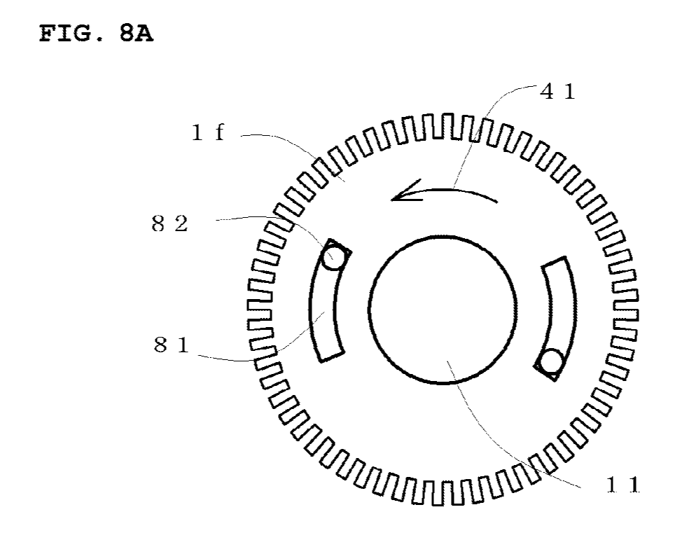

FIG. 7 is a sectional view along B-B′ of the rotating electric machine apparatus shown in FIG. 1, the second planetary gear mechanism combined with the first rotor 14 is indicated. The second sun gear 1g is fixed to the first rotor 14 which is not illustrated. Three of the second planetary gear 1q are arranged in circumferential direction, and mesh with the second sun gear 1g and the second ring gear 1m. In addition, the planetary gear shaft 1r of the second planetary gear 1q is supported by the planetary gear carrier 1t. The second ring gear 1m is displaceable with respect to the housing 12, and is rotatably constituted by an actuator not further shown. The first planetary gear mechanism arranged on the rotating shaft 11 is the same composition as the second planetary gear mechanism except for the first ring gear 1k being fixed on the housing 12, and the explanation is omitted.

An arrow of number 71 indicates rotating direction of the second sun gear 1g, an arrow of number 72 indicates rotating direction of the second planetary gear 1q, and an arrow of number 73 indicates rotating direction of the planetary gear shaft 1r. While the second ring gear 1m is stationary, the second sun gear 1g is rotated in the direction of the arrow 71, the second planetary gear 1q will rotate in the direction of the arrow 72, the planetary gear shaft 1r and the planetary gear carrier 1t are rotated in the direction of the arrow 73. The first planetary gear mechanism and the second planetary gear mechanism has the same configuration, and share the planetary gear shaft 1r. Therefore, the first rotor 14 and the rotating shaft 11 and the third rotor 16 rotates at the same rotational speed. Also, the second rotor 15 is combined by the rotor coupling mechanism with the first rotor 14 and the third rotor 16, so it rotates at the same rotating speed. Rotation of the planetary gear carrier 1t is possible to be extracted as decelerated output of the rotating shaft 11.

When the second ring gear 1m is rotated by the external actuator in the rotating direction of the rotor (the same direction as the arrow 71), the planetary gear shaft 1r is difficult to change rotating speed in direction of the arrow 73, so the rotational speed of the second planetary gear 1q becomes slow, and the rotational speed of the second sun gear 1g becomes late. Therefore, the first rotor 14 is made to be relatively displaced for the third rotor 16 in opposite direction to the arrow 71 (opposite direction to the rotating direction of the rotor). When the second ring gear 1m is rotated in opposite direction of the rotor by the external actuator, the first rotor 14 is made to be relatively displaced for the third rotor 16 in same direction to the arrow 71 (same direction to the rotating direction of the rotor). Also, the second rotor 15 is combined by the rotor coupling mechanism with the first rotor 14 and the third rotor 16, and is made to be displaced to be always located at middle circumferential position of both.

FIGS. 8A, and 8B indicate stopper structure to restrict circumferential direction displacement of the first rotor 14 for the third rotor 16. FIG. 8A is a plan view showing the first sun gear 1f seen from the second sun gear 1g side, and FIG. 8B is a plan view showing the second sun gear 1g seen from the first sun gear 1f side. A number 81 indicates a recess provided on the first sun gear 1f aspect, the stopper is configured such that the pin 82 disposed on the first rotor support 35 side is fitted in the recess 81. A number 41 indicates the rotational direction of the rotating shaft 11. Although the pin 82 is disposed on the first rotor support 35 side, the pin 82 is shown in FIG. 8A in order to make relation with the recess 81 clear. The pin 82 exists in an edge in the recess 81 in FIG. 8A, and the pin 82 is set to be able to move in the recess 81 in the rotating direction 41 only by 45 degrees in the machine angle (180 degrees in an electric angle) That is, the first rotor 14 is 180 degrees relative displaceable in the electrical angle in the rotational direction with respect to the third rotor 16.

Configuration of the rotating electric machines of the present embodiment have been described with reference to FIGS. 1 to 8. The first rotor 14, the third rotor 16 are displaced in the opposite circumferential directions each other relative to the second rotor 15, the induced voltage varies in phase with each other appears on the armature coil 19, synthesized induced voltage amplitude is inversely proportional to the displacement. The rotor coupling mechanism that mutually unites three rotors is adopted, displacing the first rotor 14 by the planetary gear mechanism, the first rotor 14 and third rotor 16 are displaced in the opposite circumferential directions each other relative to the second rotor 15.

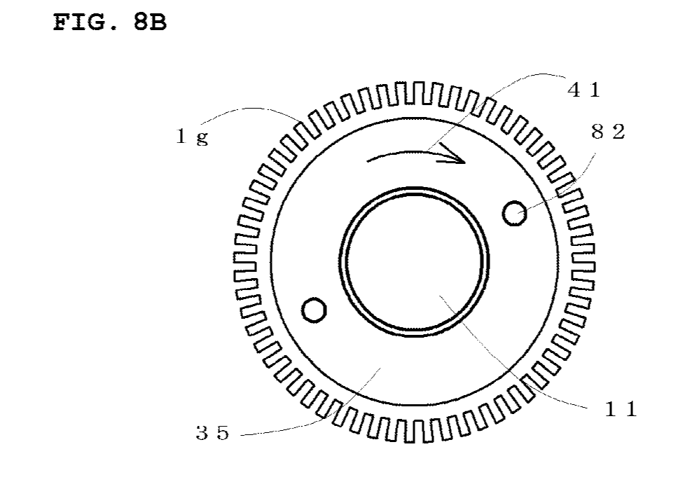

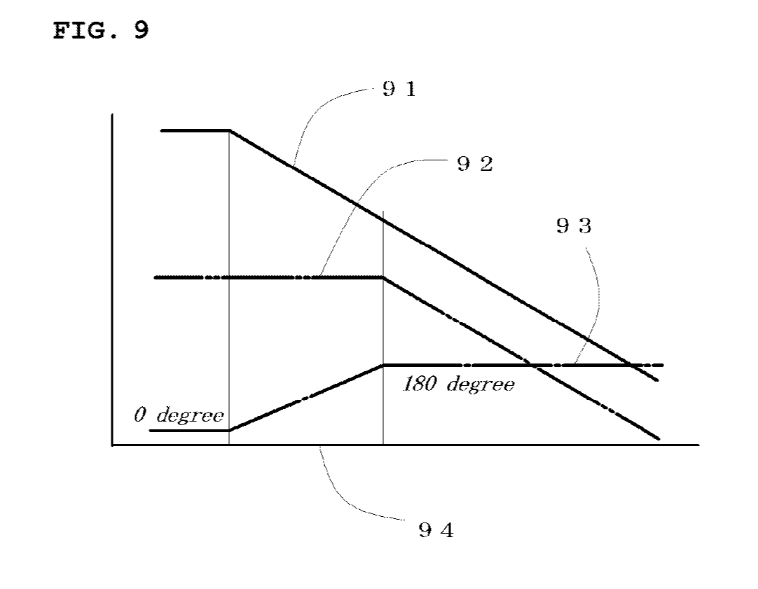

FIG. 9 shows the relationship between rotational torque, drive current and rotational speed. Horizontal axis 94 shows the rotational speed, numbers 91, 92 and 93 show rotational torque, drive current, the circumferential direction interval between both ends rotors respectively in this figure. When starting, the circumferential interval 93 of the both ends rotors is 0 degrees in electrical angle, the maximum driving current 92 is applied, the maximum torque of 91 is obtained. When the rotational speed is increased, a margin of the power supply voltage is reduced with respect to the induced voltage that appears on the armature coil 19, the circumferential interval 93 of the both ends rotors is made large, the generation voltage is suppressed, the margin of the power supply voltage is secured. The rotational torque 91 becomes small in inverse proportion to the circumferential interval 93 of the both ends rotors.

Further, when the rotational speed becomes larger and the circumferential direction interval 93 of both end rotors reaches 180 degrees, the displacement control of the rotor is stopped. The induced voltage from permanent magnets among the first rotor 14 and the third rotor 16 is counterbalanced almost completely. The rotational force of the entire rotor is obtained by the reluctance torque of the second rotor 14 at this stage. Margin of the power supply voltage to the terminal voltage of the armature coil 19 is secured by decreasing the drive current 92.

Each of the first rotor 14, the third rotor 16 is displaced. from 0 to 90 degrees in electrical angle with respect to the second rotor 14, the maximum value of the circumferential interval between the first rotor 14 and the third rotor 16 is 180 degrees. The magnetic pole of the third rotor 16 being axially opposite to the magnetic pole of the first rotor 14 is opposite polarity in each other, but the displacement control does not become difficult due to the magnetic coupling because the second rotor 14 is present therebetween.

In the rotating electric machines of this embodiment, the first rotor 14 and the second rotor 15 are displaced to the third rotor 16, and the induced voltage amplitude is controlled. However, considerable mass of the rotor, the magnetic force or the like between rotors also remains as is mitigated in the embodiment of the present invention are factors that inhibits rapid displacement of the first rotor 14, the second rotor 15. The embodiment of this invention provides the solution to this problem and lets the second ring gear 1m displace by an actuator of small power and can let the first rotor 14, the second rotor 15 displace quickly.

That is, when the second ring gear 1m is rotated in the direction opposite to the arrow 71 by the external actuator during acceleration of the rotor, the rotational driving force is added to output of the actuator through the second ring gear 1m, the displacement in the rotational direction of the first rotor 14 is advanced. Further, when the second ring gear 1m during regenerative braking is rotated in the same direction as the arrow 71 by the external actuator, regenerative braking force is added to the output of the actuator, the displacement in opposite rotational direction of the first rotor 14 is advanced. Thus according to the embodiment of this invention, the actuator can be a compact and small power type.

The second ring gear 1m receives displacement pressure in the opposite direction of the arrow 71 during acceleration of the rotor. Therefore, making the second ring gear 1m displace in opposite direction of the arrow 71 is equivalent to reduce force that binds the second ring gear 1m to the housing 12 and force that binds the first rotor 14 to the rotating shaft 11. Also, displacing the second ring gear 1m in direction of the arrow 71 during deceleration of the rotor by the regenerative braking is equivalent to reduce force that binds the second ring gear 1m to the housing 12 and force that binds the first rotor 14 to the rotating shaft 11. Thus, force to act on the rotor from the armature can be used for the rotor displacement by relaxing power to bind the first rotor 14 to the rotating shaft 11.

The embodiment of this invention proposes control method to distribute the rotational drive force added on the displacement rotors (the first rotor 14 and the second rotor 15) to displacement force for the displacement rotors and rotational drive force for the rotating shaft 11 appropriately, and the displacement rotors are displaced while continuously driving the rotating shaft 11. In this embodiment, force for binding the first rotor 14 to the rotating shaft 11 is controlled by controlling the rotational speed to rotate the second ring gear 1m in opposite direction to the arrow 71. The rotational speed of the second ring gear 1m becomes large, the force to bind the first rotor 14 to the rotating shaft 11 is weakened, and the displacement force for the displacement rotors becomes large. The rotational speed of the second ring gear 1m becomes small, the above-mentioned binding force is strengthened, and the displacement force for the displacement rotors is made small. When using the regenerative braking force to the displacement force for the displacement rotors, it is similar to the above except that the direction of rotating the second ring gear 1m is reversed.

This embodiment controls the induced voltage by using the rotational drive force, is a system for optimizing the output, and further control as the rotating electric machine system is explained. FIG. 10 indicates a block diagram of the rotating electric machine system to control the induced voltage. A number 101 indicates the rotating electrical machine equipment, and numbers 102, 103 indicate input and output of the rotating electrical machine equipment 101 respectively. Numbers 104, 105 indicate a controller and a drive circuitry respectively. A number 106 indicates an actuator which controls the position control device, and a number 107 indicates a position signal of the rotor. When the rotating electrical machine equipment 101 is employed as a generator, the input 102 is torque, and the output 103 will be generated electric power. When the rotating electrical machine equipment 101 is employed as an electric motor, the input 102 is the drive current supplied to the armature coil 19 from the drive circuitry 105, and the output 103 will be the rotating torque and the rotating speed.

In the case that the rotating electric machine is used as the electric motor, the induced voltage is controlled by utilizing the rotational drive force, and the rotational drive force is optimally controlled. When the induced voltage becomes bigger than the predetermined value, the controller 104 makes the first rotor 14 and the second rotor 15 displace in the rotating direction to the third rotor 16, makes the circumferential direction interval between the respective rotors bigger, makes decrease the induced voltage, and makes margin of the power supply for the induced voltage bigger in order to be driven more in high-speed rotation.

That is, during accelerating the rotor by supplying the drive current to the armature coil 19 from the drive circuitry 105, the controller 104 controls rotational speed of the second ring gear 1m rotating in opposite to the arrow 71 (opposite direction to the rotating direction of the rotor) by the actuator 106 so that the induced voltage may keep the predetermined value while increasing the rotational speed of the output 103, and makes the first rotor 14 and the second rotor 15 displace in the rotating direction with respect to the third rotor 16. The controller 104 will suspend displacement control for the first rotor 14 and the second rotor 15 at the location where the circumferential direction interval between the first rotor 14 and the third rotor 16 reaches 180 degrees in electrical angle. In this state, the rotor is rotated by the reluctance torque of the second rotor 15.

When the rotational speed becomes lower than a predetermined value, the controller 104 resumes displacement control for the displacement rotors. When the induced voltage becomes smaller than the predetermined value, the controller 104 makes the first rotor 14 and the second rotor 15 displace in the opposite rotating direction to the third rotor 16, makes increase the induced voltage, and makes the torque that drives the rotor large. That is, during decelerating the rotor by the regenerative braking, the controller 104 controls rotational speed of the second ring gear 1m rotating in direction of the arrow 71 (direction to the rotating direction of the rotor) by the actuator 106 so that the induced voltage may keep the predetermined value while decreasing the rotational speed of the output 103, and makes the first rotor 14 and the second rotor 15 displace in the opposite rotating direction with respect to the third rotor 16.

In this embodiment, the circumferential interval between the first rotor 14 and the third rotor 16 is changed from 0 to 180 degrees in an electric angle. However, if the upper limit of the displacement amount is set to less than 180 degrees so that the induced voltage to the armature coil 19 may remain, the rotor position can be presumed according to the induced voltage, and the timing of the driving current switch can be obtained.

In this embodiment the first rotor 14, the second rotor 15 are displaced in circumferential direction using the actuator for rotating the second ring gear 1m and rotational drive force the rotor. The first rotor 14, the second rotor 15 are displaced. exploiting a part of the rotational drive force, so the actuator is compact and small power. Furthermore, control system can be composed by exchanging the worm gear 1s, and the actuator with a clutch, a braking system that maintains circumferential position of the second ring gear 1m. The controller 104 controls the force for binding the second ring gear 1m to the housing 12, and distributes the rotational drive force, the regenerative braking force for the displacement rotors and for driving the rotating shaft 11 appropriately. Any of these configurations are included in the embodiment of the present invention.

The relative displacement amount to the second rotor 15 of the first rotor 14 and the third rotor 16 is established equally in this embodiment. However, magnetic field in phase delay is added. to the first rotor 14, magnetic field in phase advance is added to the third rotor 16. As a result, the permanent magnets of each of the rotors is over magnetized, demagnetized, respectively. Also, there is possibility that contribution degree from the first rotor 14 and the third rotor 16 to the torque of the whole rotor varies with displacement including the case that adopts the rotor structure with the reluctance torque. In that case, it is possible to choose gear ratio of the gear indicated in FIG. 6 so that relative displacement amounts of the first rotor 14 and the third rotor 16 to the second rotor 15 may be different.

The IPM is a hybrid composition that can use the magnet torque and the reluctance torque, and field weakening is performed by controlling the drive current phase. However, there are many constraints on the pole configuration for the hybrid configuration in the IPM. This embodiment is similar hybrid constitution, and the magnetic field is weakened by displacing a part of the rotor. Three rotors in this embodiment are independent, optimal magnetic pole composition of each rotor for the magnet torque or the reluctance torque can be adopted, and the induced voltage from the permanent magnet can be controlled by almost 100%.

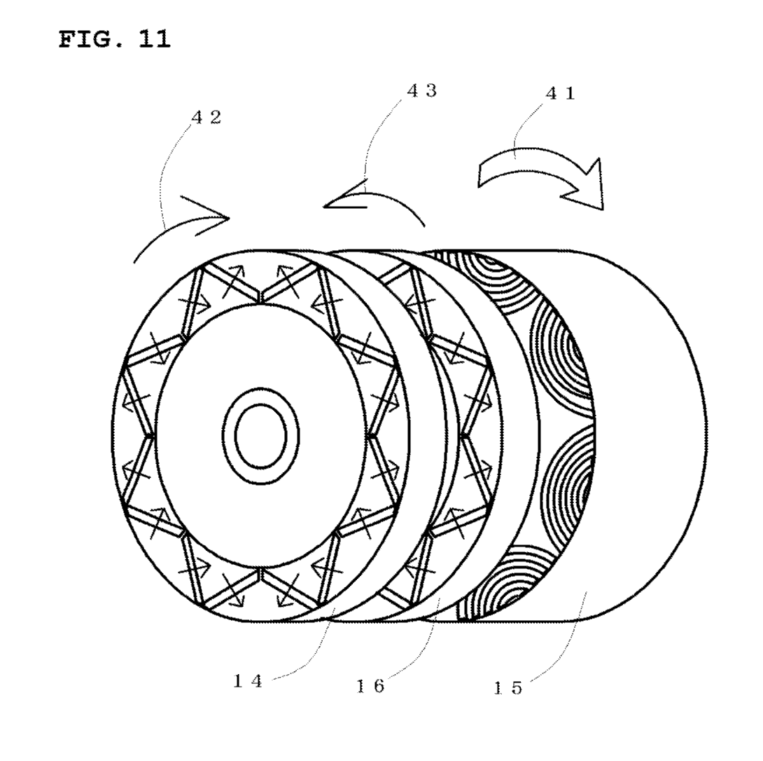

In this embodiment, the both end rotors have permanent magnets, and the middle rotor does not have permanent magnets. The composition to replace the second rotor 15 and the third rotor 16 as shown in a perspective view in FIG. 11 are also possible. In this figure, the second rotor is fixed to the rotating shaft 11 as the fixed rotor, the first rotor 14 and the third rotor 16 are displaceably held on the rotating shaft 11 as the displacement rotors. The rotor coupling mechanism combines the first rotor 14 and the third rotor 16 and the rotating shaft 11, when either of the first rotor 14 and the third rotor 16 is displaced in circumferential direction to the rotating shaft 11, the other is displaced in reverse circumferential direction. Although the interval between the first rotor 14 and the third rotor 16 should be made large to avoid magnetic coupling, the gear mechanism can be limited only to the first rotor 14 and the third rotor 16 side.

### Second Embodiment

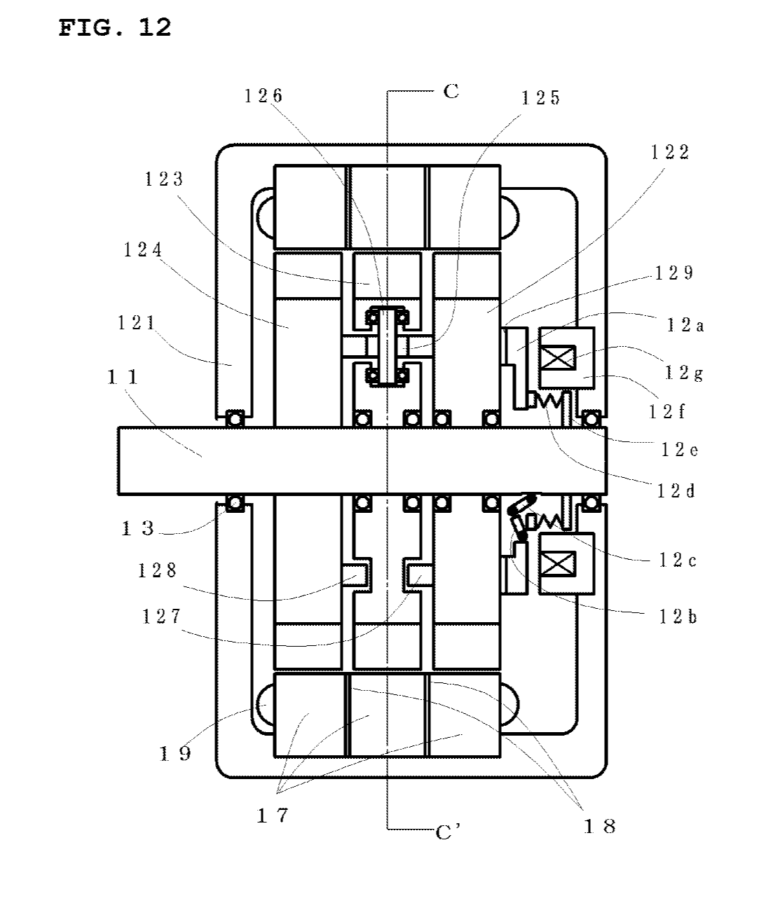

The rotating electric machine system according to a second embodiment of the present invention will be explained by using FIGS. 12 to 18. Magnet excited three rotors are opposite to an armature as a first rotor, a second rotor and a third rotor. The first rotor and the second rotor are displaced against the third rotor exploiting rotational force, regenerative braking force. The first rotor and the third rotor are configured such that the reluctance torque may not appear, the second rotor is configured to be utilizing reluctance torque.

FIG. 12 shows a longitudinal sectional view of the embodiment in which the present disclosure is applied to a rotating electric machine apparatus of an inner rotor structure, a rotating shaft 11 is supported rotatably by a housing 121 through bearings 13. The first rotor 122 and the second rotor 123 are displaceably held on the rotating shaft 11 through bearings, the third rotor 124 is fixed to the rotating shaft 11. Region where the first rotor 122 and the second rotor 123 are displaced is forward of rotating direction in common use against the third rotor 124. Numbers 19, 17, and 18 indicate the armature coil, the armature core, and the spacer made from non-magnetic insulating material, respectively.

A number 125 indicates a coupling gear, a number 126 indicates a coupling gear support shaft, and they are being maintained rotatably in the second rotor 123. The coupling gear support shaft 126 is radial direction, and three sets of the coupling gear 125 and the coupling gear support shaft 126 are arranged in circumferential direction in this embodiment. Numbers 127, 128 indicate side gears arranged on the first rotor 122 side and the third rotor 124 side respectively. Each of side gears 127 and 128 has a gear carved in a circumferential direction, and is arranged to mesh with the coupling gear 125. A rotor coupling mechanism consists of the coupling gear 125, the coupling gear support shaft 126, the side gear 127 and the side gear 128. The side gear 127 and the side gear 128 rotate in an opposite direction each other, so when one of the first rotor 122 and the third rotor 124 is displaced in circumferential direction to the second rotor 123, the other is displaced in reverse circumferential direction.

Numbers 129, 12a, 12d and 12e indicate a clutch plate, a movable clutch plate, a spring, and a spring stopper, respectively. The moveable clutch plate 12a is pressed against the clutch plate 129 by the spring 12d. Furthermore, numbers 12c, 12b indicate arms. The rotating shaft 11 and the arm 12c, the arm 12c and the arm 12b, the arm 12b and the movable clutch plate 12a are connected by pivotable joints, respectively. Three sets of this arm assembly are arranged in circumferential direction. The movable clutch plate 12a can be displaced in parallel to the rotating shaft 11 and rotates with the rotating shaft 11.

Numbers 12g, 12f indicate an excitation coil around the rotating shaft 11, an excitation core that cross section is C-shaped and goes around the rotating shaft 11, respectively. And the excitation core 12f is fixed to the housing 121. Magnetic material is at least used for the movable clutch plate 12a member on the excitation core 12f side. A rotor position control device includes of the clutch plate 129, the movable clutch plate 12a, the arm 12c, the arm 12b, the spring 12d, the spring stopper 12e, the excitation core 12f and the excitation coil 12g, etc.

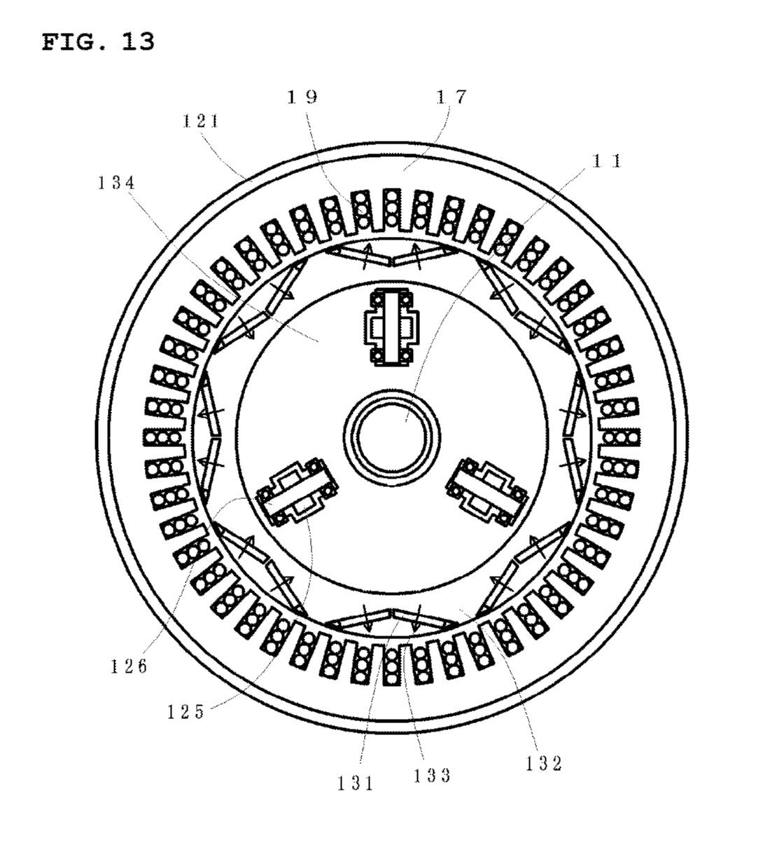

FIG. 13 is a sectional view along C-C′ of the rotating electric machine apparatus shown in FIG. 12, and indicates section of the armature and the second rotor 123. The armature has the same configuration as the first embodiment, the same numbers are attached to the same members, repeated descriptions of which are omitted. The second rotor 123 is composed of a second rotor support 134, and magnetic pole part arranged on outer periphery thereof. Permanent magnets are embedded in magnetic material so that the magnetic pole part can get magnet torque and reluctance torque. That is, the permanent magnets 131 are inserted into slots of the rotor core 132 which silicon steel plates are laminated. A number 133 indicates magnetization direction of the permanent magnet 131, 8 magnetic salient poles (8 poles) by which polarity turned over alternately in circumferential direction are arranged.

The second rotor support 134 is composed of a non-magnetic stainless steel, and is displaceably held on the rotating shaft 11. Three sets of the coupling gear 125 and the coupling gear support. shaft 126 are disposed in the second rotor support 134.

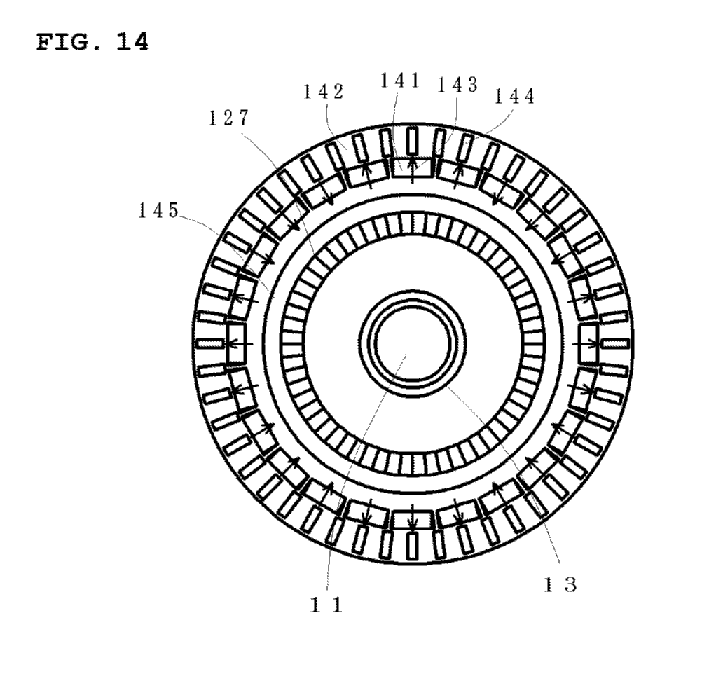

FIG. 14 is a plan view of the first rotor 122 of the rotating electric machine apparatus shown in FIG. 12 seen from the second rotor 123 side. The magnetic pole part consists of a rotor core 142 that silicon steel plates are laminated, a permanent magnet 141, a non-magnetic material 144. One magnetic salient pole includes three permanent magnets 141, polarities of 8 magnetic salient poles (8-poles) are turned over alternately in circumferential direction. An arrow 143 indicates magnetization direction of the permanent magnet 141. The permanent magnet 141 is embedded in the side away from the armature in the rotor core 142, the non-magnetic material 144 is inserted within radial slit provided in the rotor core 142 closer to the armature from the permanent magnet 141. The permanent. magnets 141, the non-magnetic material 144 are arranged at equal intervals in the circumferential direction, inductance of the armature coil 19 due to the rotation of the first rotor 122 is almost. constant, the first rotor 122 is configured so that reluctance torque is hardly to exist.

The side gear 127 is disposed on the first rotor support 145. The side gear 128 of same shape as the side gear 127 is placed on the third rotor 124 side so that the longitudinal section view is shown in FIG. 12, and the magnetic pole part of the third rotor 124 is the same as magnetic pole part of the first rotor 122.

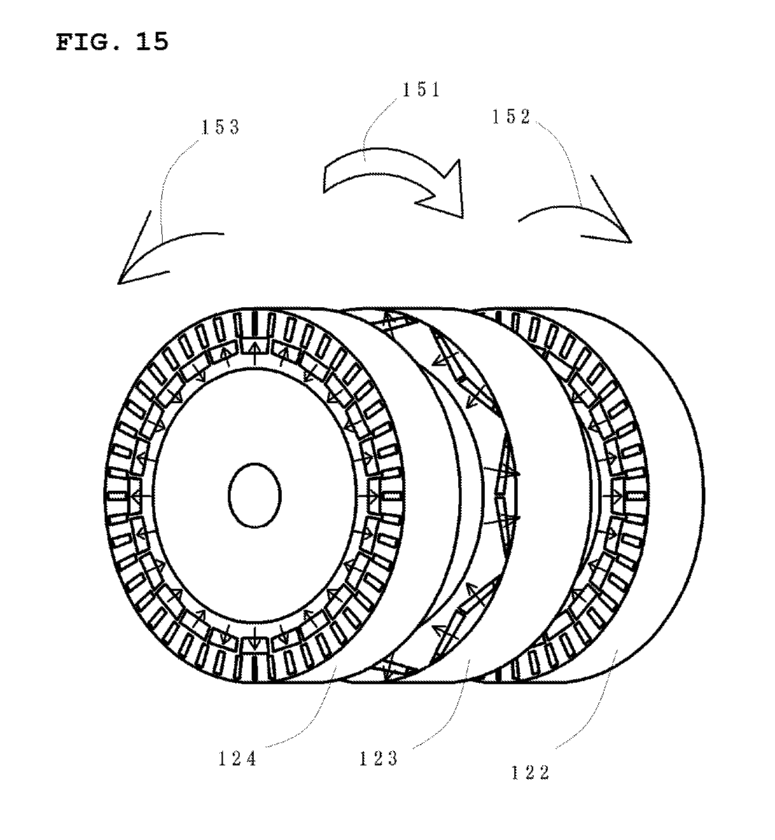

In this embodiment, the third rotor 124 is fixed to the rotating shaft 11, the first rotor 122 and the second rotor 123 are displaced to the third rotor 124 in the rotating direction. However, based on the second rotor 123 in the middle, the first rotor 122 and the third rotor 124 are displaced relatively in the circumferential direction opposite to each other with respect to the second rotor 123, and induced voltage of the armature coil 19 is controlled. FIG. 15 is a perspective view in model manner showing relative displacement direction of the first rotor 122 and the third rotor 124 to the second rotor 123. Arrows 152, 153 indicate the direction in which the first rotor 122, the third rotor 124 is displaced relative to the second rotor 123, respectively. An arrow 151 indicates the direction of rotation of the entire rotor.

Drive current polarity is switched based on the relative position between the magnetic salient poles of the second rotor 123 and the armature coil 19, so the first rotor 122 and the third rotor 124 are equivalent to be rotated by driving current of the phase advance or delay phase, respectively with respect to the second rotor 123. Therefore, there is a possibility of the appearance of the reluctance torque of a reverse-polarity in the rotors at both ends mutually and causing the torque fluctuation of the rotor. Since the present embodiment employs the magnetic pole structure of the reluctance torque-free, the anxiety is a little.

Configuration of the rotating electric machines of the second embodiment have been described with reference to FIGS. 12 to 15. The magnet torque and the reluctance torque are available for the second rotor 123 which is the middle rotor of this embodiment. Axial length of the first rotor 122 and the third rotor 124 in both ends is equal, and respective relative amount of displacement to the second rotor 123 is equal. So, each contribution to the induced voltage amplitude in the armature coil 19 is equal. Thus, the circumferential position of the synthetic magnetic poles of the both end rotors can be set at the magnetic salient pole position of the second rotor 123, and polarity of drive current is switched based on relative position between the armature coil 19 and the magnetic salient pole of the second rotor 123. The torque of the second rotor 123 becomes biggest at a position where of the driving current phase is advanced (for example, an electrical angle of about 20 degrees). The reference position of the displacement rotor is set to a position where each torque of the second rotor 15, the first rotor 14, and the third rotor 16 become maximum.

Assuming ω as angular frequency, t as time, and the electrical angle 2θ as circumferential interbal between adjacent rotors, respectively, induced voltages from the second rotor 123, the first rotor 122, the third rotor 124 to the armature coil 19 are proportional to Sinωt, Sin (ωt+2θ), Sin(ωt−2θ), respectively. When the ratio of the induced voltage amplitude to which the first rotor 122, the second rotor 123 and the third rotor 124 contribute is made q:p:q, the induced voltage is (4*q*Cosθ*Cosθ+p−2*q)*Sinωt. The ratio that the first rotor 122, the second rotor 123 and the third rotor 124 contribute to the induced voltage amplitude is 3:4:3 in this embodiment, maximum amplitude is normalized by 1.0, and the induced voltage amplitude is 1.2*Cosθ*Cosθ−0.2.

As explained above, so the induced voltage amplitude is proportional to 1.2*Cosθ*Cosθ−0.2. Range of displacement amount 2θ is up to the induced voltage polarity is reversed, the range of displacement amount 2θ is about 132 degrees from zero. Therefore, displacement range of the second rotor 123 against the third rotor 124 is from zero to about 132 degrees, and the displacement range of the first rotor 122 is from zero to about 264 degrees. Because the circumferential interval between rotors that are axially adjacent is up to 132 degrees, it is difficult to cause magnetic coupling.

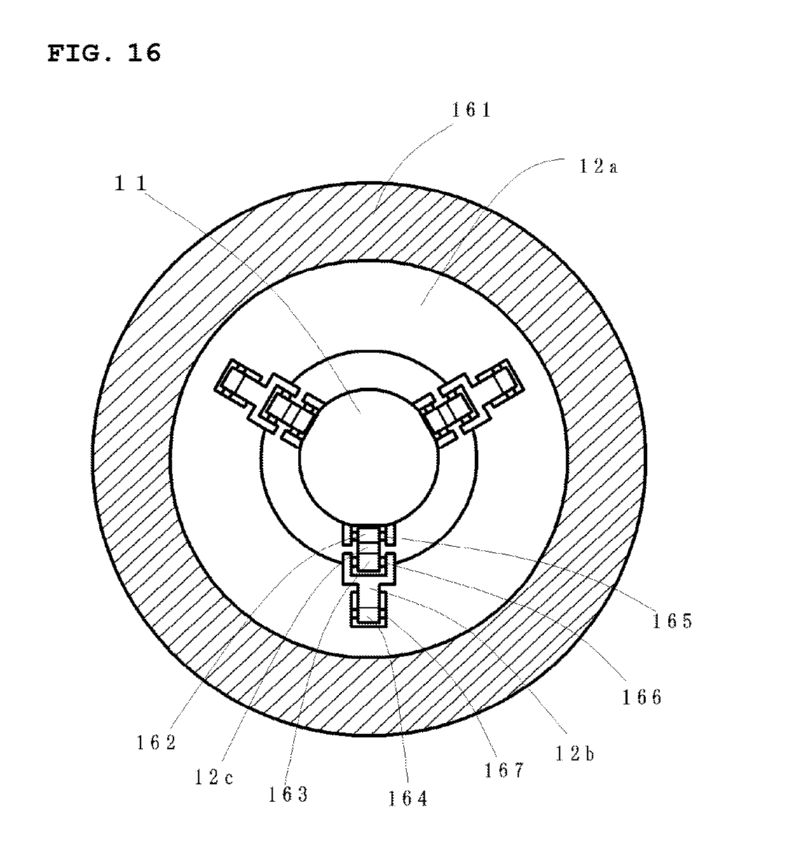

FIG. 16 is a plan view of the rotor position control device seen from the first rotor 122 side, the configuration of the rotor position control device is further described. The movable clutch plate 12a is a structure around the rotating shaft 11, a number 161 indicates sliding surface of the movable clutch plate 12a in contact with the clutch plate 129. Rotational force is transmitted between the clutch plate 129 and the sliding surface 161 of the movable clutch plate 12a.

The movable clutch plate 12a is supported on the rotating shaft 11 by 3 sets of the arm assembly as shown in FIG. 16. Joint parts 162, 163 are arranged in both ends of the arm 12c. The joint 162 is pivotable about a pin 165 which is fixed to the rotating shaft 11, the joint 163 is pivotable about a pin 166 which is fixed to the arm 12b. The joint 164 disposed on the arm 12b further is configured to be rotatable about a pin 167 which is fixed to the movable clutch plate 12a.

Thus the movable clutch plate 12a is supported on the rotating shaft 11 by three sets of the arm assembly that consist of the arm 12c, the arm 12b, the joint 162, the joint 163, and the joint 164, the joint 162, the joint 163, and the joint 164 are configured to be rotatable in the plane of the longitudinal sectional view shown in FIG. 12. Therefore, the movable clutch plate 12a. rotates together with the rotating shaft 11 as well as a displaceable in a direction parallel to the rotating shaft 11.

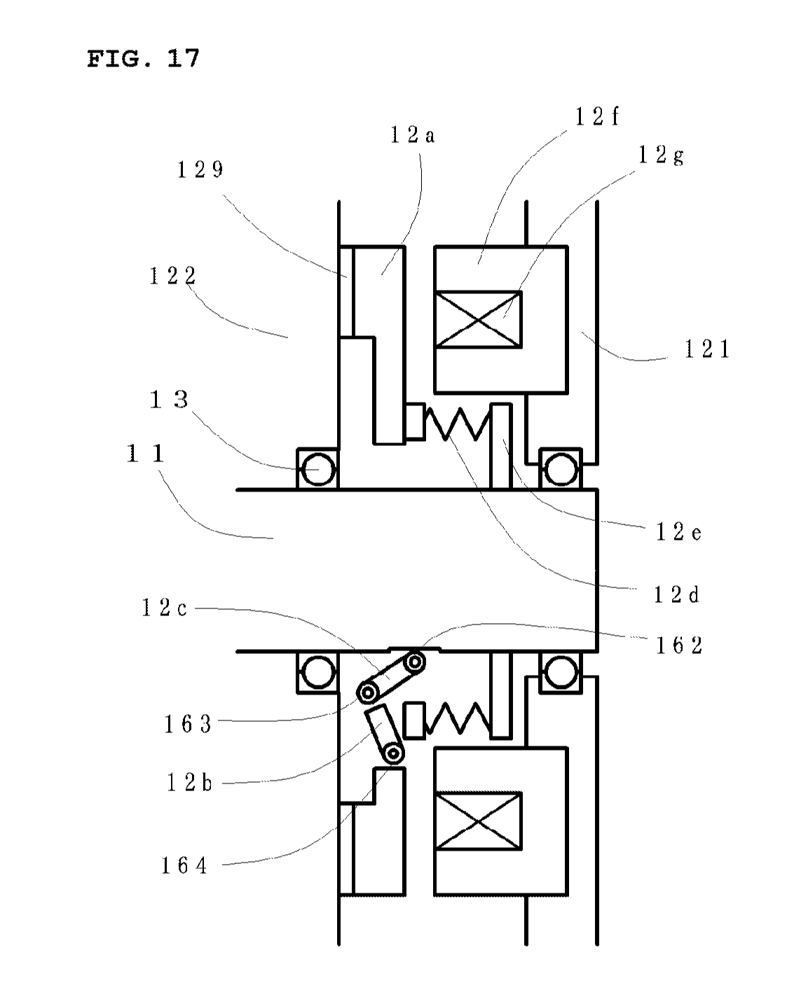

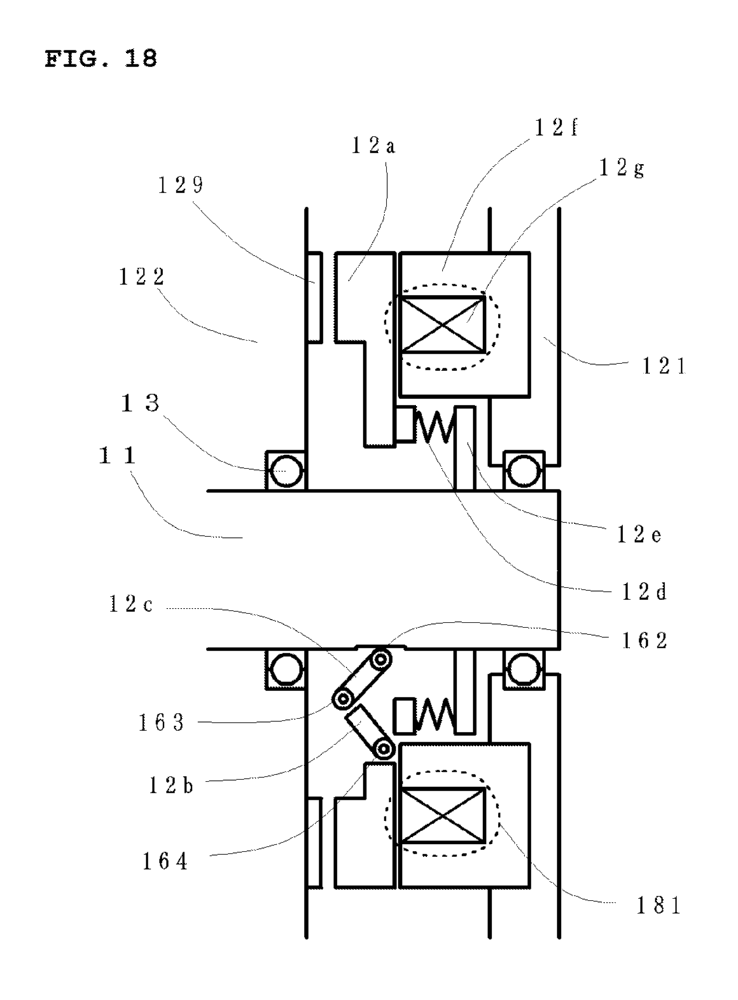

Operation of the rotor position control device is described with reference to FIGS. 17, 18. FIG. 17 indicates magnified view of the rotor position control device in the rotating electric machine apparatus shown in FIG. 12. The movable clutch plate 12a is pressed by the spring 12d on the clutch plate 129, and state where the rotational torque is transmitted between the clutch plate 129 and the movable clutch plate 12a is illustrated. The first rotor 122, the second rotor 123, and the third rotor 124 rotate together with the rotating shaft 11 in this state.

FIG. 18 shows a state in which the movable clutch plate 12a has been moved away from the clutch plate 129 in FIG. 17. When the excitation current is applied to the excitation coil 12g, a excitation magnetic flux 181 is induced in the excitation core 12f, the moveable clutch plate 12a is attracted to the excitation core 12f side, and is pulled away from the clutch plate 129. FIG. 18 shows this state, the third rotor 124 rotates together with the rotating shaft 11, coupling between the rotating shaft 11 and the first rotor 122 is released, and the first rotor 122 is ready to rotate free to the rotating shaft 11.

When rotational drive force is given to the rotor from the armature coil 19 in the state shown in FIG. 18, the third rotor 124 is accelerated together with the rotating shaft 11 and the rotational load, the first rotor 122 and the second rotor 123 are more easily accelerated because inertia moment thereof is less than the third rotor 124 and the rotational load, and are made to be displaced in the rotating direction with respect to the third rotor 124. If the rotational drive force in the reverse direction is applied so as to decelerate the rotor, or when regenerative braking is applied, the first rotor 122 and the second rotor 123 are displaced to opposite rotating direction with respect to the third rotor 124.

When making the excitation current flowing the excitation coil 12g big, the force against the spring 12d will be bigger, and when making the exciting current small, the force against the spring 12d becomes smaller. In this embodiment, controlling the magnitude of the excitation current, the movable clutch plate 12a and the clutch plate 129 are allowed to slide relative to each other as an intermediate state of FIGS. 17 and 18, and a part of the rotational drive force or the regenerative braking force that is transmitted between the movable clutch plate 12a and the clutch plate 129 is made to be distributed as the displacement force for the first rotor 122 and the second rotor 123.

The first rotor 122 and the second rotor 123 are displaced by the rotational drive force or the regenerative braking force. The second rotor 123 is displaced so as to be always positioned in middle between the first rotor 122 and the third rotor 124, because the first rotor 122, the second rotor 123, and the third rotor 124 are coupled to each other by the rotor coupling mechanism.

In the rotating electric machine apparatus shown in FIG. 18 from FIG. 12, it has been described that the first rotor 122 and the second rotor 123 can be displaced relative to the third rotor 124. This embodiment is a system for optimizing the output by controlling the induced voltage, the control of the rotating electric machine system is further explained with reference to FIG. 10. FIG. 10 shows the block diagram of the rotating electric machine system for the induced voltage control, has been described in the first embodiment, the number 106 in this embodiment is replaced with an excitation circuitry for supplying the excitation current to the excitation coil 12g.

In the case where the rotating electric machine is used as an electric motor, the induced voltage is controlled, then the rotational drive force is optimally controlled. And the rotational drive force and the regenerative braking force are exploited for the induced voltage control. When the induced voltage appearing in the armature coil 19 becomes larger than a predetermined value, the controller 104 makes the first rotor 122 and the second rotor 123 displace in the rotating direction with respect to the third rotor 124, makes circumferential direction interval between adjacent rotors larger, makes the induced voltage reduce, and makes a margin of power supply voltage to the induced voltage larger so as to be driven at higher speed rotation.

That is, during accelerating the rotor by supplying the drive current to the armature coil 19 from the drive circuitry 105, the controller 104 controls the excitation current to the excitation coil 12g by the excitation circuitry 106, controls force to impose the movable clutch plate 12a to the clutch plate 129, and makes the first rotor 122 and the second rotor 123 relative to the third rotor 124 displace in rotating direction.

When the induced voltage appearing in the armature coil. 19 becomes smaller than a predetermined value, the controller 104 makes the first rotor 122 and the second rotor 123 displace in opposite rotating direction to the third rotor 124, makes the induced voltage larger, and makes torque to drive the rotor larger. That is, during decelerating the rotor by the regenerative braking, the controller 104 controls the excitation current to the excitation coil 12g by the excitation circuitry 106, controls the force to impose the movable clutch plate 12a to the clutch plate 129, and makes the first rotor 122 and the second rotor 123 displace in the opposite rotating direction relative to the third rotor 124 so that the induced voltage may keep the predetermined value while decreasing the rotational speed of the output 103.

As for the above-mentioned rotational force control, the optimum conditions are different according to the combination of materialized magnetic pole composition and the rotor. Driving conditions including drive current amplitude, the relative displacement of the both ends rotors, and the switching timing of the drive current are depending on the rotating state, and is determined by taking into consideration the rotational torque and the energy efficiency. The driving conditions are stored in the controller 104 as a data map in advance, the rotor is rotated with reference to the data map.

In this embodiment, the first rotor 122 and the second rotor 123 are made to be displaced by the rotational drive force or the regenerative braking force, however the regenerative braking force at a low rotational speed may not be sufficient, and the displacement rotors may not return to the reference position even if the rotation stops. In that case, the controller 104 restricts the rotating shaft 11 to be hard to rotate, makes the drive circuitry 105 supply the drive current to the armature coil 19 so that the first rotor 122 and the second rotor 123 rotate toward the reference position, controls the excitation current to the excitation coil 12g from the excitation circuitry 106 at the same time, makes loosen the force pressing the movable clutch plate 12a to the clutch plate 129, and makes the first rotor 122 and the second rotor 123 return to the reference position.

In the present embodiment, the controller 104 controls the pressing force of the movable clutch plate 12a, makes the movable clutch plate 12a and the clutch plate 129 slide mutually, and distributes the rotational drive force or the regenerative braking force to the displacement force for the first rotor 122 and the second rotor 123. This embodiment is transformed and the following methods are possible. Composing of a concave-convex shape to fit the movable clutch plate 12a and the clutch plate 129 to each other, the controller 104 makes state of FIG. 17 and FIG. 18 cause alternately, controls duration ratio of each, and controls the displacement force for the first rotor 122 and the second rotor 123.

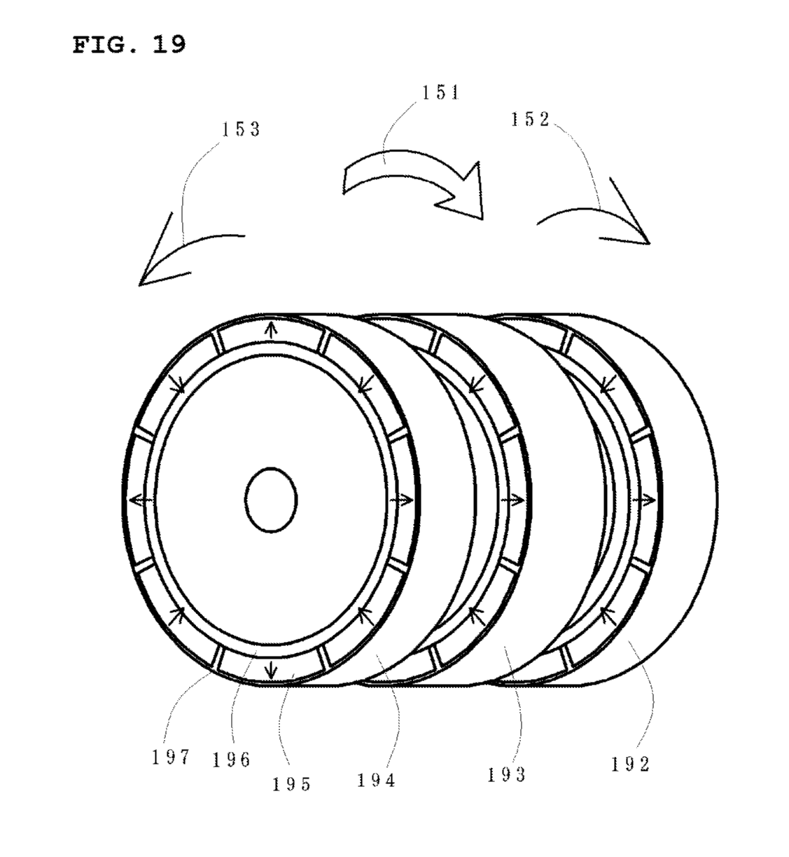

Present embodiment is composed of three magnet excited rotors. In addition, the magnetic pole part can be changed into surface magnet composition as shown in FIG. 19. FIG. 19 is a perspective view in model manner showing the state in which the first rotor 192, the second rotor 193, the third rotor 194 with surface magnet configuration are arranged. Magnetic pole part of each rotor is composed of permanent magnets 195 and a rotor core 196. A number 197 shows a cylindrical hull to prevent the permanent magnet 195 from dispersing, and is composed of non-magnetic stainless steel. This configuration is possible to obtain a large starting torque.

As shown in the first and the second embodiment, magnetic field with leading phase and late phase is added to the rotors at both ends respectively, and the magnet is demagnetized or magnetized more. Energy may be consumed by the process, and there is a possibility that the energy efficiency decreases. So it is desirable for the rotors at both ends to adopt the permanent magnet with enough thickness or with enough coercivity.

The rotating electric machine system of the embodiment of the present invention has been explained above. These embodiments are mere examples for realizing the theme or the purpose of the embodiment of the present invention and do not limit the scope of the invention. For example, the rotating electrical machine apparatus of the embodiment of the present invention can be naturally composed by changing the combination of the pole configuration of the rotor, the armature configuration, and the rotor position control device, etc. in the above-mentioned embodiments.

According to the embodiment of the present invention, the induced voltage can be suppressed easily, the rotating electric machine system of a wide rotational speed range is provided, and is expected to high energy efficiency. Further, rotational speed control including the induced voltage control is carried out continuously, and the rotating electric machine system can be used as a drive source for an air conditioner, a vehicle or the like.

Obviously, numerous modifications and variations of the present invention are possible in light of the above teachings. It is therefore to be understood that within the scope of the appended. claims, the invention maybe practiced otherwise than as specifically described herein.

What is claimed is:

1. A rotating electric machine system comprising:
a housing;
an armature having a plurality of circumferentially disposed armature coils;
a rotor having a plurality of circumferentially disposed magnetic salient poles and opposing radially to the armature and being rotatable together with a rotating shaft;
the rotor comprising three rotors with magnetic salient poles of the same number and queuing up axially, rotors at both ends being magnet excited at least, one of the three rotors being fixed to the rotating shaft as a fixed rotor, and the other two rotors being configured to be displaceable in the circumferential direction relative to the fixed rotor as displacement rotors; and
a rotor position control device;
when induced voltage is bigger than predetermined value, the rotor position control device makes the rotors at both ends displace relatively in reverse circumferential direction each other to a middle rotor, makes each of the displacement amount larger, and makes the induced voltage smaller,
when the induced voltage is smaller than predetermined value, the rotor position control device makes each of said displacement amount smaller, and makes the induced voltage bigger,
rotational force is optimally controlled.

2. The rotating electric machine system according to claim 1,
wherein the rotors at both ends are composed so that the induced voltage amplitude from each of the rotors at both ends may become equal, the polarity of the driving current is switched based on a relative circumferential position between the armature coil and the middle rotor, and the rotor is driven to rotate.

3. The rotating electric machine system according to claim 1,
wherein the rotors at both ends are configured so that magnetic. resistance in the circumferential direction is uniform, and inductance of the armature coil due to rotating rotors at both ends is constant.

4. The rotating electric machine system according to claim 1,
wherein the middle rotor is configured so that magnetic. resistance in the circumferential direction changes periodically, and inductance of the armature coil due to the rotating middle rotor varies periodically.

5. The rotating electric machine system according to claim 1,
wherein the three rotors are combined mechanically so that when either of two displacement rotors is displaced in the circumferential direction, the rotors at both ends may be displaced relatively in reverse circumferential direction each other to the middle rotor.

6. The rotating electric machine system according to claim 1,
wherein the rotor position control device has a rotor coupling mechanism,
a first planetary gear mechanism, and a second planetary gear mechanism;
wherein the rotor coupling mechanism has side gears surrounding the rotating shaft and being fixed on the rotors at both ends, coupling gear(s) being rotatably disposed in the middle rotor, and is configured so that each of the side gears engages the coupling gear(s);
wherein the first planetary gear mechanism has a first sun gear fixed to the rotating shaft, a first ring gear fixed to the housing, a first planetary gear meshing with the first sun gear and the first ring gear, and a planetary gear support shaft;
wherein the second planetary gear mechanism has a second sun gear fixed to one of the two displacement rotors, a second ring gear disposed rotatably in the housing, and the planetary gear support. shaft being shared with the first planetary gear mechanism;
wherein the second ring gear is displaced in the circumferential direction, and relative displacement amount of each rotor at both ends for the middle rotor is changed.

7. The rotating electric machine system according to claim 6,
wherein one of the rotors at both ends is fixed to the rotating shaft as a fixed rotor, other two rotors are configured to be displaceable in same circumferential direction relative to the fixed. rotor as displacement rotors;
wherein the rotor position control device has an actuator to displace the second ring gear in circumferential direction;
wherein the rotor position control device makes the second ring gear displace through the actuator in the circumferential direction so as to rotate the second sun gear faster than the first sun gear during accelerating of the rotor, and displacement amount of the displacement rotor is increased by utilizing the rotational drive force;
wherein the rotor position control device makes the second ring gear displace through the actuator in the circumferential direction so as to rotate the second sun gear slower than the first sun gear during decelerating the rotor by the regenerative braking, and displacement amount of the displacement rotor is decreased by utilizing the regenerative braking force.

8. A rotating electric machine system comprising:
a housing;
an armature having a plurality of circumferentially disposed armature coils;
a rotor having a plurality of circumferentially disposed magnetic salient poles and opposing radially to the armature and being rotatable together with a rotating shaft;
the rotor comprising three rotors with magnetic salient poles of the same number and queuing up axially, one of the three rotors being fixed to the rotating shaft as a fixed rotor, and the other two rotors being configured to be displaceable in the circumferential direction relative to the rotating shaft as displacement rotors, the displacement rotors being magnet excited at least; and
a rotor position control device;
when induced voltage is bigger than predetermined value, the rotor position control device makes the displacement rotors displace relatively in reverse circumferential direction each other to the rotating shaft, makes each of the displacement amount larger, and makes the induced voltage smaller,
when the induced voltage is smaller than predetermined value, the rotor position control device makes each of said displacement amount smaller, and makes the induced voltage bigger,
rotational force is optimally controlled.

9. A method for controlling an induced voltage for a rotating electric machine system comprising an armature having a plurality of circumferentially disposed armature coils and a rotor having a plurality of circumferentially disposed magnetic salient poles and opposing radially to the armature and being rotatable,
said method comprising:
comprising three rotors with magnetic salient poles of the same number for the said rotor;
queuing up the three rotors axially;
arranging permanent magnets for rotors at both ends at least;
fixing one of the the three rotors to a rotating shaft as a fixed rotor, and configuring other two rotors to be displaceable in the circumferential direction relative to the fixed rotor as displacement rotors;
arranging a side gear orbiting the rotating shaft to each of the rotors at both ends;
arranging a coupling gear(s) being rotatably disposed in the middle rotor;
engaging the coupling gear(s) with each of the side gears so that the rotors at both ends are displaced in opposite circumferential directions each other relative to the middle rotor;
varying displacement amount of one of the displacement rotors in the circumferential direction with respect to the fixed rotor, making the rotors at both ends displace in opposite circumferential directions each other relative to the middle rotor; and
controlling the induced voltage.

10. A method for controlling an induced voltage for a rotating electric machine system comprising an armature having a plurality of circumferentially disposed armature coils and a rotor having a plurality of circumferentially disposed magnetic salient poles and opposing radially to the armature and being rotatable,
said method comprising:
comprising three rotors with magnetic salient poles of the same number for the said rotor;
queuing up the three rotors axially;
arranging permanent magnets for rotors at both ends at least;
fixing one of the rotors at both ends to a rotating shaft as a fixed rotor, and configuring the other two rotors to be displaceable in the circumferential direction relative to the fixed rotor as displacement rotors;
combining the three rotors mechanically so that when either of two displacement rotors is displaced in the circumferential direction, the rotors at both ends may be displaced relatively in reverse circumferential direction each other to the middle rotor;
having a device to bind the displacement rotor to the rotating shaft;
loosening force for binding the displacement rotors to the rotating shaft when the rotational force is acting on the rotor from the armature,
making the displacement rotors displace to the fixed rotor, and controlling the induced voltage.

11. A method for controlling an induced voltage for a rotating electric machine system comprising an armature having a plurality of circumferentially disposed armature coils and a rotor having a plurality of circumferentially disposed magnetic salient poles and opposing radially to the armature and being rotatable,
said method comprising:
comprising three rotors with magnetic salient poles of the same number for the said rotor;
queuing up the three rotors axially;
arranging permanent magnets for rotors at both ends at least;
fixing one of the rotors at both ends to a rotating shaft as a fixed rotor, and configuring the other two rotor- to be displaceable in circumferential direction relative to the fixed rotor as displacement rotors;
combining the three rotors mechanically so that when either of two displacement rotors is displaced in the circumferential direction, the rotors at both ends may be displaced relatively in reverse circumferential direction each other to a middle rotor;
fixing a first sun gear to the fixed rotor;
fixing a first ring gear to a housing;
meshing a first planetary gear to the first sun gear and the first ring gear;
fixing a second sun gear to one of the two displacement rotors;
arranging a second ring gear to be rotatable by an actuator;
meshing a second planetary gear to the second sun gear and the second ring gear;
sharing a planetary gear support shaft so that the first planetary gear and the second planetary gear rotates together;
controlling rotational speed of the second ring gear rotating in the opposite rotational direction to the rotor by the actuator, making the displacement rotor displace relative to the fixed rotor in rotational direction as well as continuing the rotational speed increase during accelerating the rotor, and then reducing the induced voltage;
controlling rotational speed of the second ring gear rotating in the rotational direction to the rotor by the actuator, making the displacement rotor displace relative to the fixed rotor in opposite rotational direction as well as continuing the rotational speed decrease during decelerating the rotor by regenerative braking, and then increasing the induced voltage.

12. A method for controlling a rotational force for a rotating electric machine system comprising an armature having a plurality of circumferentially disposed armature coils and a rotor having a plurality of circumferentially disposed magnetic salient poles and opposing radially to the armature and being rotatable,
said method comprising:
comprising three rotors with magnetic salient poles of the same number for the said rotor;
queuing up the three rotors axially;
fixing one of the rotors to a rotating shaft as a fixed rotor, and configuring the other two rotors to be displaceable in circumferential direction relative to the fixed rotor as displacement rotors;
arranging permanent magnets for rotors at both ends;
configuring a middle rotor so that magnetic resistance along rotor periphery in the circumferential direction is varied periodically and reluctance torque becomes present and rotational torque becomes obtained by the reluctance torque;
making the rotors at both ends displace relatively in reverse circumferential direction each other to the middle rotor, making each of the displacement amount larger, and making the induced voltage smaller when induced voltage is bigger than predetermined value; and
making each of said displacement amount smaller, and making the induced voltage bigger when induced voltage is bigger than predetermined value, and controlling the rotating force optimally.
